(19) United States
(12) Patent Application Publication
(10) Pub. No.: US 2012/0222132 A1
(43) Pub. Date: Aug. 30, 2012

(54) Permissions Based on Behavioral Patterns

(75) Inventors: Douglas C. Burger, Redmond, WA (US); Marc Eliot Davis, San Francisco, CA (US); Eric J. Horvitz, Kirkland, WA (US)

(73) Assignee: Microsoft Corporation, Redmond, WA (US)

(21) Appl. No.: 13/035,603

(22) Filed: Feb. 25, 2011

(51) Int. Cl. G06F 21/24

(52) U.S. Cl. 726/28

(57) ABSTRACT

Users may choose to have their behavior analyzed in order to infer default sharing permission settings for documents and other information maintained in one or more computer systems. This may increase information security for the users and streamline implementation of privacy and/or sharing permissions. The default sharing permissions are implemented by a computer system as soft permissions that may be used to determine which documents are to be shared with which recipients. The soft permissions may address sharing situations for which a user has not expressly indicated his or her sharing rules. The soft permissions may change over time in response to changing user behavior and/or the soft permissions may be revised in light of user feedback.

### BACKGROUND

Typically, permissions for sharing computer files or electronic documents are based on express user settings. A user can grant access permissions to other users individually or to a group of users. Many users have numerous types of documents stored in different places and managed according to different sharing rules. Increased interconnectivity through computer systems and the Internet creates a large number of other users that could potentially receive shared documents. Managing permissions for a large number of documents with respect to a large number of potential recipients may be time consuming and confusing. Thus, the permission settings that are ultimately applied to a user's documents may be significantly different from how the user would choose to share documents if he or she deliberately specified sharing permissions for each document.

For example, the user may be over exclusive and share less information than he or she desires because it is inconvenient to change a “no sharing” default to allow sharing for specific friends and groups. Conversely, in other situations the sharing may be over inclusive. As a reaction to “no sharing” default settings, the user may select a “share all” or public setting for information. This may result in sharing information that the user would not have elected to share if he or she performed a more detailed analysis of what to share with whom. In other words, most blanket or default sharing rules are unlikely to consistently share the right documents with the right people.

The problem remains that users would like to have the “right” sharing mix without the tedium of specifying exactly which documents should be shared with which other users or groups.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The subject of this disclosure is directed to generation and implementation of soft permissions for sharing documents. Soft permissions are sharing rules derived automatically by computer systems using artificial intelligence, mathematical models, and the like to infer appropriate sharing permissions. The soft permissions may attempt to approximate the sharing permissions that a user would select if he or she spent a significant amount of time and effort manually setting permissions for each document and each potential recipient.

In one implementation, a system analyzes actions of a user related to sharing of a document with other people. The actions may include such things as sharing the document with another user or setting a sharing permission that applies to the document. Considerations may also include the nature of the relationships of the people with whom the document is being shared including as an example multiple attributes of the link structure of the network of relationships among the owner of the data and all of the recipients. The system may derive a soft permission for sharing a document with other recipients and/or sharing other documents based on the analysis of the user's actions. Upon receiving explicit or implicit permission from the user, the system may use that soft permission to determine potential recipients for the same and other documents. Sharing actions may occur with or without confirmations or logging, depending on the nature and configuration of a system for managing access and sharing privileges. Sharing actions or privileges may be induced by prior behaviors and then assumed in guiding future actions, based on a specification of the owners of data to follow one of more inferred policies, or in proposing sharing actions to owners of data that would only be shared after confirmations are received by the owners.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an illustrative system including a soft permissions infrastructure for managing sharing of documents between a user and potential recipients.

FIG. 2 is a block diagram showing the soft permissions infrastructure and the permissions database of FIG. 1 in greater detail.

FIG. 3 is schematic diagram showing classification of potential recipients and documents.

FIG. 4 is a schematic diagram showing sharing of a voice model with a potential recipient.

FIG. 5 is a flowchart showing an illustrative method of determining potential recipients based on a soft permission.

FIG. 6 is a flowchart showing an illustrative method of modifying a soft permission based on user feedback.

FIG. 7 is a block diagram of an illustrative computing device usable to interact with a soft permissions infrastructure.

### DETAILED DESCRIPTION

The disclosure describes generation of rules for sharing documents with other users. A user may manually specify sharing permissions for individual documents or categories of documents and/or for individual users or groups of users. However, there may be many situations in which the user's manually specified permissions do not assist in deciding whether to share or not share a particular document with a potential recipient. There is an effort versus accuracy spectrum where low effort often correlates with inaccurate sharing rules (e.g. not the “right” sharing) and high effort is required to obtain the desired balance between sharing and privacy.

To assist the user in achieving his or her desired balance between sharing and privacy, this disclosure introduces techniques for developing soft permissions. The soft permissions may help the user avoid applying an inappropriate default rule such as prohibiting sharing when the user would wish that a document be shared, or allowing sharing when the user would want to restrict access. The soft permissions comprise inferences regarding how the user would choose to share a document in a given situation. By developing and applying soft permissions, possibly in addition to “hard” permissions explicitly set by the user, the systems discussed in this disclosure may enable greater document security and an enhanced ability to share documents while improving user convenience.

### Illustrative System Including a User and Potential Recipients

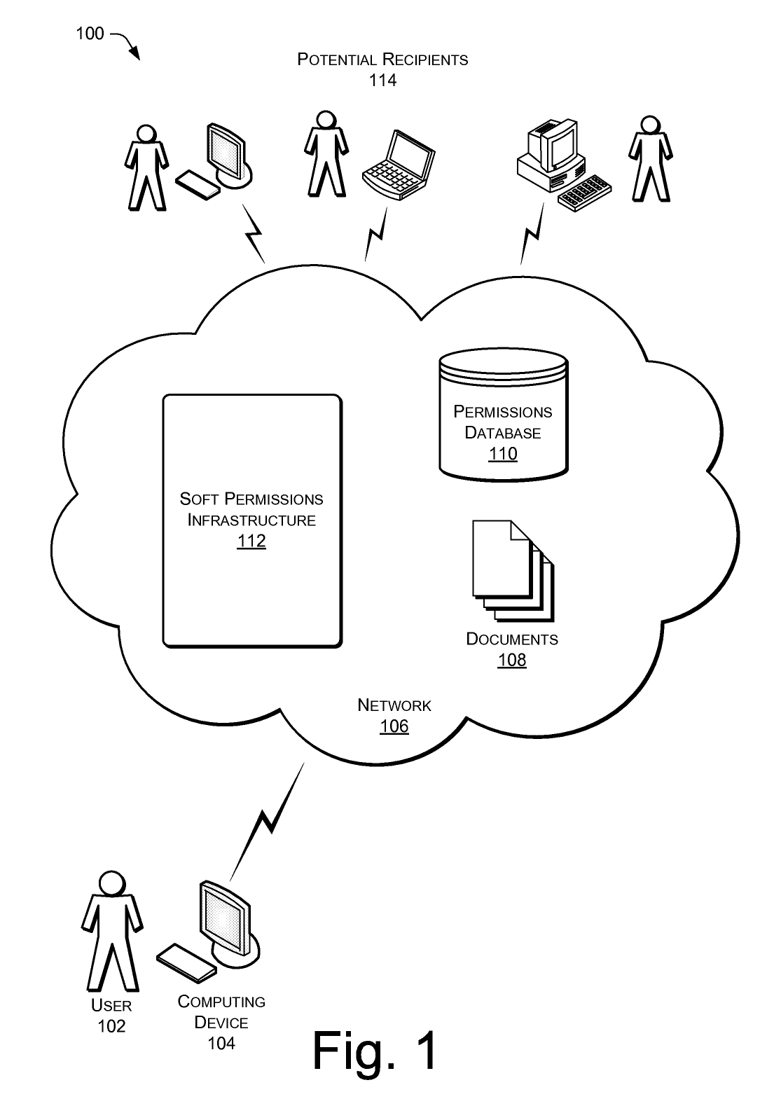

FIG. 1 shows an architecture 100 of a system with a user 102 interacting with a computing device 104 having access to a network 106. The computing device 104 may be a conventional desktop or laptop computer, a set-top box, a gaming console, a mobile phone, a personal digital assistant, a thin client, or the like. The network 106 may be any type of wired and/or wireless network having any type of configuration such as the Internet, a wide area network (WAN), a local area network (LAN), a cable network, a plain old telephone service (POTS) network, a cellular network, a mesh network, a peer-to-peer network, etc.

The network 106 may contain items 108 to which the user 102 can control access. The documents 108 may include documents that could be viewed as belonging to another person (e.g., a child's documents on a computer controlled by a parent, an employee's documents on a computer network controlled by a network administrator, etc.), but the user 102 (e.g., the parent or network administrator) is able to control the sharing of these documents 108. The documents 108 may be any type of computer- or machine-accessible data such as word processing files, spreadsheet files, e-mails, audio files, digital photographs, videos, and the like.

“Document” as used herein includes portions of a file as well as an entire file. For example, one page out of a multi-page word processing file may be a separate document for management of sharing permissions even if, for example, a file directory system manages all pages together as a single file for directory organization purposes. One chapter of a video may be a separate document for management of sharing permissions even though that chapter may be stored on an optical disk along with other chapters of the same video. The documents 108 may exist in the network 106 on a server, in a cloud computing system, or within a computing device or storage device connected to the network 106. For example, some or all of the documents 108 may be stored on the computing device 104 of the user 102.

The network 106, or a device connected to the network 106, may also include a permissions database 110 that stores permissions specifying with whom documents 108 may be shared. The permissions database 110 may include the permissions in a list or any other type of data structure. The permissions may include default rules for sharing documents. The default rules are rules that exist unless the user 102 or a computer system provides alternate rules. Default rules may be set by a manufacture, a network administration, or by a user during setup. The permissions database 110 may also include other types of permissions such as “hard” permissions and/or “soft” permissions both of which are discussed in greater detail below.

A soft permissions infrastructure 112 may also exist within the network 106. The soft permissions infrastructure 112 may be located on a single device within the network 106 such as a server, or distributed across multiple devices in the network 106, such as in a cloud computing system. The soft permissions infrastructure 112 may also be maintained in whole or part by the computing device 104 or another device connected to the network 106. The soft permissions infrastructure 112 generates soft permissions, or flexible rules, for sharing the documents 108. The soft permissions are developed by one or more computing techniques and serve to allow and/or restrict sharing of documents based on inferred intent of the user 102.

The soft permissions developed by the soft permission infrastructure 112 are one technique for deciding which other users are permitted to receive the documents 108 of the user 102. The soft permissions may also regulate transmission and/or editing of documents 108. “Receiving” as used herein includes receiving a document or a copy of a document as well as accessing a document to view, read, listen, etc. to the content of the document. The other users connected to the network 106 with computing devices capable of receiving the documents 108 are shown here as potential recipients 114. Permissions applied to a given document regulate sharing of that document, whether or not that document is actually shared. Accordingly, the other users that are capable of receiving a document, regardless of whether the document is shared, are referred to as potential recipients 114.

Some of the documents 108 may be public documents that may be received by all or substantially all of the potential recipients 114. One example of a public document is a public web page. Other of the documents 108 may be private documents that are not shared with any of the potential recipients 114 and are accessible only by the user 102. Examples of private documents may include a personal diary or journal, financial records, etc. Many of the documents 108 will have sharing permissions that fall somewhere between the extremes of public documents and private documents. Some, but less than all, of the potential recipients 114 may be permitted to receive these documents.

Further details about how the soft permissions infrastructure 112 helps the user 102 establish sharing permissions for his or her documents 108 are discussed below.

### Illustrative Soft Permissions Infrastructure and Permissions Database

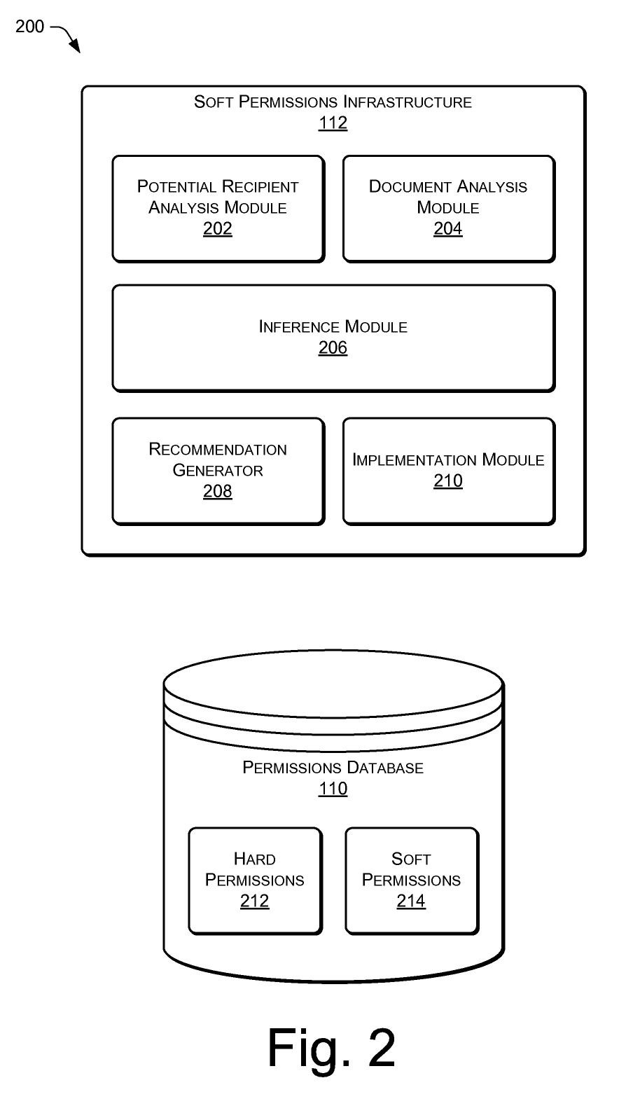

FIG. 2 shows a schematic diagram 200 of the soft permissions infrastructure 112 and the permissions database 110 of FIG. 1. As discussed above, the soft permissions infrastructure 112 may be distributed over multiple computing devices both within the network 106 and connected to the network 106. The soft permissions infrastructure 112 may include a potential recipient analysis module 202, a document analysis module 204, an inference module 206, a recommendation generator 208, and an implementation module 210.

The potential recipient analysis module 202 may be configured to analyze data derived from interactions between the user 102 and one or more of the potential recipients 114 of a document 108. The potential recipient analysis module 202 may determine a level of trust for individual ones of the potential recipients 114. The level of trust may be represented as a relative level (e.g., high, medium, or low), as a numerical level such as from 0-100 (e.g., 0 corresponds to a lowest level of trust and 100 corresponds to a highest level of trust), or in any other way that defines a relative level of trust of each recipient.

The interactions between the user 102 and the potential recipients 114 may include correspondence such as e-mail exchanges, phone calls, text messages, and the like. For example, frequency of phone calls and time to call back may be used to determine the strength of a relationship. A higher frequency of calls and/or shorter time delay before returning a call may both indicate a stronger relationship and higher level of trust. Behavior patterns that include temporal information such as time and date may also be used to infer or detect relationships. For example, a calendar of the user may include indications of places and times such as when the user 102 is scheduled to be a particular conference room. Identification of potential recipients 114 who were also schedule and/or actually present in the same conference room at the same time may be a further source of relationship information. Persons that tend to be at the same places at the same times may be inferred to have a stronger relationship.

Other interactions that may be analyzed by the potential recipient analysis module 202 include sharing of documents 108 such as the sending of a document as an attachment or providing a link to a document. Categorization of a potential recipient 114 by the user 102 is a further type of interaction. Categorization may include placing the potential recipient 114 in a white list or black list. Other types of categorization include placing a potential recipient 114 in a contact list, identifying the potential recipient 114 as a friend, and the like.

The potential recipient analysis module 202 may generate a social graph connecting the user 102 and one or more potential recipients 114. The social graph may be based in part on analysis of interactions and relationships detected or derived by the soft permissions infrastructure 112 and based in part on social graph data imported into the soft permissions infrastructure 112 (e.g., persons linked to the user 102 in a social or professional website).

The document analysis module 204 may be configured to perform an analysis of the documents 108 to determine a level of document privacy for one or more of the documents 108. The level of document privacy may be represented as a relative level (e.g., high, medium, or low), as a numerical level such as from 0-100 (e.g., 0 corresponds to a lowest level of privacy and 100 corresponds to a highest level of privacy), or in any other way that defines a relative level of privacy of a document.

The analysis may include an analysis of text found within the documents 108 through techniques such as semantic mining. For documents 108 that contain data other than text, voice recognition may be applied to audio data, image recognition (e.g., facial recognition) may be applied to picture or video data, and the like.

Other types of document analysis include analysis of metadata, for example. The metadata may be associated with one of the documents 108 by the user 102, by a third party, or automatically by a computer system. For example, a document 108 that is shared, may allow other users to tag or comment on the document 108. That metadata provided by third parties can then be used in subsequent analysis of the document 108. Automatic association of metadata with a document 108 may include such things as using image recognition to determine that a first photograph without metadata is similar to a second photograph that is tagged as being a picture of the Eiffel Tower and then automatically adding an Eiffel Tower tag to the first picture. Facial recognition may also be applied to a photograph or video to identify the people shown in that document 108 and set permissions based on the identities of the people shown. Additionally, document analysis may include analysis of a type or category of document such as picture, word processing, specific file type, etc.

The inference module 206 may be configured to derive soft permissions for sharing documents 108 based on the level of trust as determined by the potential recipient analysis module 202 and the level of privacy as determined by the document analysis module 204. The inference module 206 may compare the privacy level for a given document with the trust level of a potential recipient to determine if sharing should be permitted. The sharing determination may be based on a threshold level of trust and/or privacy. For example, as the level of trust for a potential recipient increases the level of privacy of documents that may be shared with that potential recipient may also increase. Assuming, by way of illustration only, that each of the trust level and the privacy level are represented on a numerical scale of 0-100 as discussed above, a given potential recipient with a trust level of 80 may be allowed to receive documents with a privacy level of 80 or lower, for example.

Various classification (explicitly and/or implicitly trained) schemes and/or systems (e.g., support vector machines, neural networks, expert systems, Bayesian belief networks, fuzzy logic, data fusion engines, etc.) can be employed by the inference module 206. The inference module 206 can provide for reasoning about or infer levels of privacy and/or trust from a set of observations of past sharing behavior of the user 102, hard rules expressly provided by the user 102, categorization of documents and/or potential recipients, and the like. Inference can be employed by the inference module 206, for example, to identify a specific context or action, or to generate a probability distribution of a likelihood that a given document has a certain privacy level and/or a given potential recipient has a certain trust level. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. For example, the inference module 206 may utilize data from multiple sources such as an e-mail account, a social networking website, a photo sharing/viewing website, etc.

The inference module 206 may use a classifier function that maps an input attribute vector, x=(x₁, x₂, x₃, x₄, xₙ), to a confidence that the input belongs to a class, that is, f(x)=confidence(class). Such classification can employ a probabilistic and/or statistical-based analysis (e.g., factoring into the analysis utilities and costs) to prognose or infer a sharing permission that the user 102 desires. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Training data may include hard rules provided by the user 102, past sharing activities of the user 102 such as sending documents as attachments to various recipients, whitelists of trusted users or public documents, blacklists of untrusted users or private documents, and the like. Other directed and undirected model classification approaches include, e.g., naïve Bayes, Bayesian networks, decision trees, neural networks, fuzzy logic models, and probabilistic classification models providing different patterns of independence. Classification as used herein also is inclusive of statistical regression that is utilized to develop models of priority.

The soft permissions infrastructure 112 may also include a recommendation generator 208. The recommendation generator 208 may be configured to identify documents 108 and/or potential recipients 114 for which a currently applied sharing permission results in a different sharing decision than one of the soft permissions. For example, if the user 102 has permissions set for a website containing personal photographs to allow anyone from the user's contact list to view the photographs this may allow the user's boss to be one of the potential recipients for those personal photographs. If the inference module 206 has generated a soft permission that would prevent the user's boss from viewing personal documents this creates a difference between the currently applied sharing permissions (i.e., share the photographs with the boss) and the soft permission (i.e. do not share the photographs with the boss). The recommendation generator 208 may generate a recommendation that the user 102 change the permissions setting for the website containing the personal photographs.

The recommendation generator 208 may periodically compare the sharing permissions as actually applied with the soft permissions derived by the inference module 206 to identify any discrepancies. The discrepancies may be instances in which the currently applied sharing permissions result in over sharing or in under sharing of documents 108 relative to the soft permissions. The recommendation generator 208 may generate a list of discrepancies for review by the user 102. The list a discrepancies could be in the form of a top 10 sharing “issues” list generated for the user 102 weekly, a number one sharing “issue” generated for the user 102 daily, or some other combination of frequency and number of identified discrepancies.

The recommendation generator 208 may rank the sharing discrepancies based on degree of deviation from a threshold. For example, the ability of a potential recipient with a trust level of only 20 to receive a document with a privacy level of 90 (a difference of 70) may be ranked as a more serious sharing “issue” than a potential recipient with a trust level of 85 and being able to receive the document with the privacy level of 90 (a difference of 5).

The recommendation generator 208 may alternatively or additionally rank the sharing discrepancies based on probability of the potential recipient actually receiving the document. For example, factors similar to those analyzed by the inference module 206 may be analyzed to infer a likelihood of the user's boss actually viewing the website with personal photographs and compare this likelihood to the likelihood of other sharing “issues.” A sharing “issue” with a higher probability of occurrence may receive a higher or more serious ranking than one with a lower probability.

The ranking of recommendations generated by the recommendation generator 208 may also rank sharing issues differently depending on whether the issue is one of over sharing or under sharing. For example, sharing a document with a potential recipient that has a trust level 5 points lower than the soft permissions suggest may be ranked as a more serious sharing discrepancy than not sharing a document with a potential recipient that has a trust level 5 points higher than a threshold determined by the soft permissions.

The soft permissions infrastructure 112 may also include the implementation module 210. The implementation module 210 is configured to implement the soft permissions derived by the inference module 206. The implementation module 210 may automatically apply the soft permissions to share or to not share one of the documents 108. Implementing the soft permissions may affect sharing by changing the permission settings for a document 108 so that a potential recipient 114 becomes able or unable to retrieve the document 108. The implementation module 210 may automatically apply the soft permissions itself by directly changing permission settings for one or more documents 108. The implementation module 210 may also provide instructions to another module or computer system that in turn directly apply the soft permissions.

Instead of automatically applying the soft permissions, the implementation module 210 may also query the user 102 regarding sharing or not sharing the documents 108 according to the soft permissions. For example, the implementation module 210 may generate a message asking the user 102 if he or she wishes to apply a soft permission. The soft permission could then be implemented if the user 102 indicates that he or she so desires.

The user 102 may be able to select the circumstances in which soft permissions are applied automatically and the circumstances in which soft permissions are applied after querying the user 102. For example, the user 102 may require that the implementation module 210 ask before applying a soft permission to a highly private document (e.g., a document with a privacy level above a threshold). The user 102 may also configure the soft permissions infrastructure 112 to automatically apply soft permissions that restrict sharing but to query the user 102 before applying soft permissions that increase sharing.

For each instance or sharing or potential sharing, actions of the implementation module 210 may be grouped into four categories: (1) share, (2) do not share, (3) query the user directly regarding sharing or not sharing, or (4) seek additional information. When deciding between one of the four options the implementation module 210 may use the techniques described above such as logistic regression, probabilistic graphical models, and Support Vector Machines, to infer a probability that the user 102 would elect to share or not share. The soft permissions infrastructure 112 (e.g., the implementation module 210) may also determine a confidence or probability that the user 102 choose to engage in a particular sharing action. When this confidence is above a threshold, the implementation module 210 may automatically (1) share or (2) not share. If the confidence is below the threshold, the implementation module 210 may (3) query the user 102. This query may include a recommendation (e.g., The photos you shared with John today are similar to the photos you shared with Amanda last week. Would you like to also share today's photos with Amanda?).

The implementation module 210 may also determine that (4) additional information either from the user 102, from an electronic source (e.g., metadata about a document 108), or from another person (e.g., a potential recipient 114) may enable a decision to be made regarding sharing or not sharing. The additional information may be information about a potential recipient 114 that could be analyzed by the potential recipient analysis module 202. The additional information could also be information about a document 108 that could be analyzed by the document analysis module 204.

The permissions database 110 stores permissions specifying with whom documents 108 may be shared. The permissions database 110 may include hard permissions 212 that are permissions expressly provided by the user. Hard permissions 212 are generally inflexible permissions that the soft permissions infrastructure 112 may not change or override without authorization from the user 102. For example, the user may designate a document 108 as a “public” thereby providing a hard permission 212 that authorizes sharing with any potential recipient 114. Similarly, the user 102 may specify that all members of “Team X” have permission to receive documents in a Team X folder and potential recipients 114 that are not members of Team X are denied permission to access files in the Team X folder.

The permissions database 110 may also store soft permissions 214 generated by the soft permissions infrastructure 112. The soft permissions 214 may be thought of as “flexible” permissions and that the permissions may evolve and change as the inference module 206 analyzes and makes inference about the user's sharing behavior. For example, the hard permissions 212 may be a basis for the inference module 206 to derive the soft permissions 214. As the user 102 adds or updates the hard permissions 212 the soft permissions 214 may also change based on the changes to the hard permissions 212. Soft permissions 214 may also include user-specified permissions as well as permissions automatically derived by the soft permissions infrastructure 112. For example, the user 102 may manually specify a permission setting, but indicated that it is a soft permission and subject to change by the soft permissions infrastructure 112.

In some implementations, the implementation module 210, or another component, may refer to the permissions database 110 in order to implement the permission settings.

### Illustrative Classification of Documents and Potential Recipients

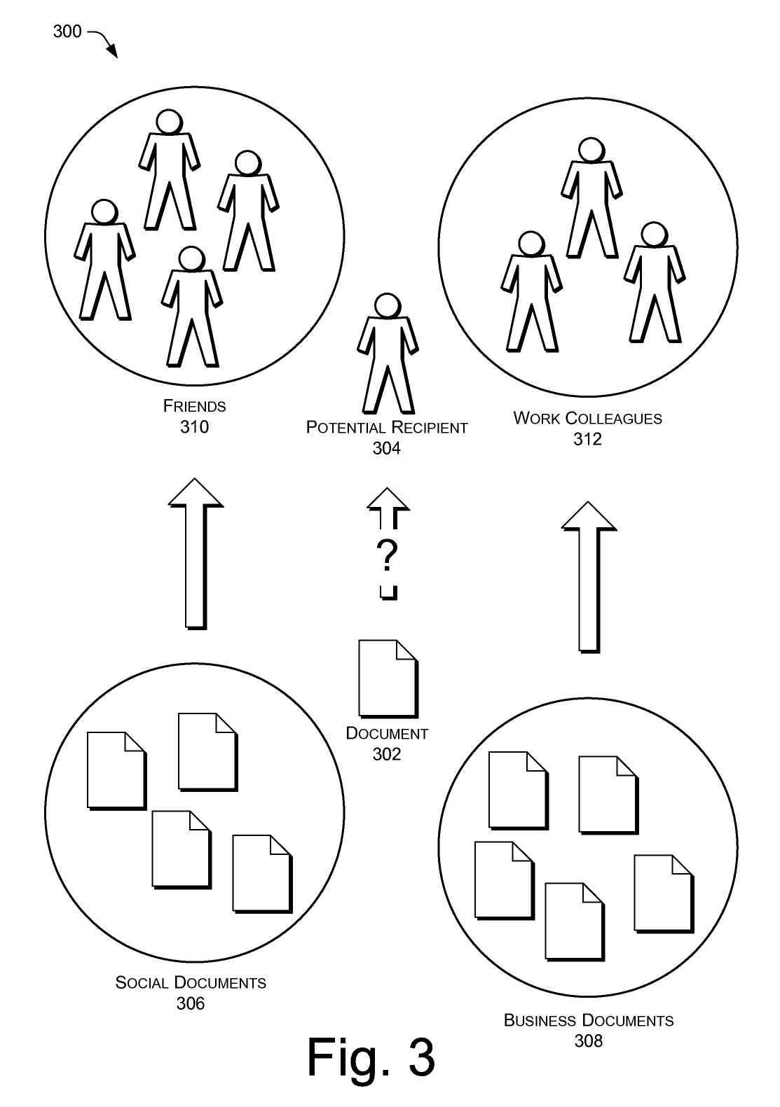

FIG. 3 shows an illustrative classification of potential recipients and documents. The soft permissions infrastructure 112 shown in FIGS. 1 and 2 may derive soft permissions based on classifications of potential recipients and/or documents. Classification of potential recipients or of documents may allow the soft permissions infrastructure of 112 to treat similar items alike by applying the same permissions to all items in a classification.

For example, the soft permissions infrastructure 112 may need to determine whether or not permission should be granted to share a document 302 with a potential recipient 304. The decision to grant or not grant permission to the potential recipient 304 to receive the document 302 may be based on the classification of the potential recipient 304 and/or based on the classification of the document 302.

Documents such as the documents 108 shown in FIG. 1 and the document 302 may be grouped into a number of categories. In some implementations, the document analysis module 204 shown in FIG. 2 may perform the grouping or classification of documents. Illustrative categories could include social documents 306 (e.g., personal e-mail, pictures of events with friends, favorite music, etc.) and business documents 308 (e.g., work e-mail, reports, financial statements, presentations, etc.). Other types of categories, meta-categories, sub-categories, and the like are also possible. Each document may be classified in one or more categories or may not belong to any category.

Documents may be classified into categories by numerous techniques such as classification by file type, semantic mining of document content, flags, tags, metadata, time of creation, recipients of the document, and the like. For example, all files created by presentation software (i.e., as determined by file type) may be classified as business documents 308 and all files posted to a social networking site (e.g., FaceBook®) may be classified as social documents 306. As further examples, all e-mail messages (and attached content) sent to other users that are in a contact list labeled or tagged as friends may be classified as social documents 306 and all e-mail messages (and attached content) sent between 8:00 am and 5:00 pm on weekdays may be classified as business documents 308.

Potential recipients of a document such as potential recipients 114 shown in FIG. 1 and the potential recipient 304 may also be grouped into categories. In some implementations, the potential recipient analysis module 202 shown in FIG. 2 may perform the grouping or classification of potential recipients. Illustrative categories could include friends 310 and work colleagues 312. Other types of categories, meta-categories, sub-categories, and the like are also possible. Each potential recipient may be classified in one or more categories or may not belong to any category. The categorization of the potential recipient 304 may be based on known or inferred relationships with the user 102 and with other friends 310, work colleagues 312, and the like.

A given potential recipient may be classified according to information available about that person and/or by interactions between the user and the potential recipient. For example, if the potential recipient and the user both have accounts on a same social networking site, the relationship as self-identified by the user and the potential recipient (e.g., FaceBook® friends, LinkedIn™ co-workers, etc.) may be used to classify the potential recipient. As an additional example, the timing of interactions between the user and the potential recipient may suggest a classification of the potential recipient (e.g., correspondence primarily during working hours suggests that the recipient is a work colleague 312 and correspondence primarily on the evenings and weekends may suggest classification as a friend 310).

Additionally, sharing behavior and a social graph connecting two people may be evaluated together to capture the nature of the sharing behavior as it relates to the social graph. For example, certain types of documents (e.g., document 302) may be shared primarily with recipients within two or fewer degrees of separation on the social graph. Connections through the social graph may also inform sharing decisions based on similarity of relationships. For example, if Joe is indicated as a friend of the user 102 according to the social graph and Joe frequently shares .jpeg files with Rhonda, who is Joe's friend, then the user 102 may also wish to share .jpeg files with Rhonda. This inference may be generated even if the user 102 has no history of sharing with Rhonda. Depending on the confidence level of the inference, the user 102 may be asked to confirm that he or she wishes to share .jpeg files with Rhonda.

Moreover, the classification of documents 108 and classification of potential recipients 114 may inform the classification of each other. For example, potential recipients that have received social documents 306 may be classified as friends 310 in part because they received documents classified as social documents 306. Similarly, documents that are sent to potential recipients classified as work colleagues 312 may be classified as business documents 308 because of the classification of the recipients.

For the document 302 in this example, a determination as to whether or not to share with the potential recipient 304 may be resolved by classifying the document 302 and/or the potential recipient 304 and then applying the appropriate permissions based on the respective classifications. Assume that there is a sharing permission (hard or soft) indicating that social documents 306 are shared with friends 310 but not work colleagues 312 and another sharing permission (hard or soft) indicating that business documents 308 are shared with work colleagues 312 but not with friends 310. The document analysis module 204, possibly in conjunction with the inference module 206, may classify this document 302 as a business document 308. For example, the document 302 may be a presentation document that includes terms such as “revenue,” “quarter,” and “forecast” which support an inference that it is a business document 308.

The potential recipient 304 may be an individual that has previously received photographs from the user tagged with terms like “party.” Correspondence between the user and the potential recipient 304 is predominately by text message and 90% of the correspondence occurs after 6 pm. These factors may lead the potential recipient analysis module 202, perhaps in conjunction with the interference engine 206, to classify this potential recipient 304 as a friend 310. Accordingly, document 302 would not be shared with the potential recipient 304 in this example.

Sharing permissions may be inferred based on classifications as shown in the example above or by considering documents and potential recipients without analyzing classifications. In some implementations, the soft permissions infrastructure 112 may determine if a soft permission should be derived from classifications by evaluating the relative computational efficiency of using or not using classifications to make the determination. For example, if an unclassified document is a mp3 file on a certain website and all other mp3 files on that website are classified as social documents 306 it may be relatively computationally simple to infer that this unclassified mp3 document is also a social document 306. As an additional example, if an unclassified potential recipient 304 has e-mail exchanges with the user both during working hours and on nights and weekends, and the potential recipient 304 has previously received documents classified as both social documents 306 and business documents 308 it may be difficult (i.e., computationally expensive) to classify this potential recipient 304 as a friend 310 or as a work colleague 312. According, analyzing and drawing inferences from other aspects of the user's past behavior may be a more computationally efficient way to determine a sharing permission.

Classifications of potential recipients 304 and of documents 302 may be used to propagate changes across multiple potential recipients 304 and/or multiple documents 302. For example, the user may explicitly provide a new hard permission that several documents classified as financial documents are no longer to be shared with a potential recipient classified as family but only with a financial planner and an accountant. These changes may be automatically applied to all other potential recipients 304 classified as family and all other documents 302 classified as financial documents. Similarly, the inference module 206 may develop a new soft permission for some documents 302 or potential recipients 304 and if a further inference determines that the same soft permission would be appropriate for an entire classification of documents 302 and/or potential recipients 304 then the soft permission may be propagated across the entire class of documents and/or class of potential recipients.

### Illustrative Usage Scenario

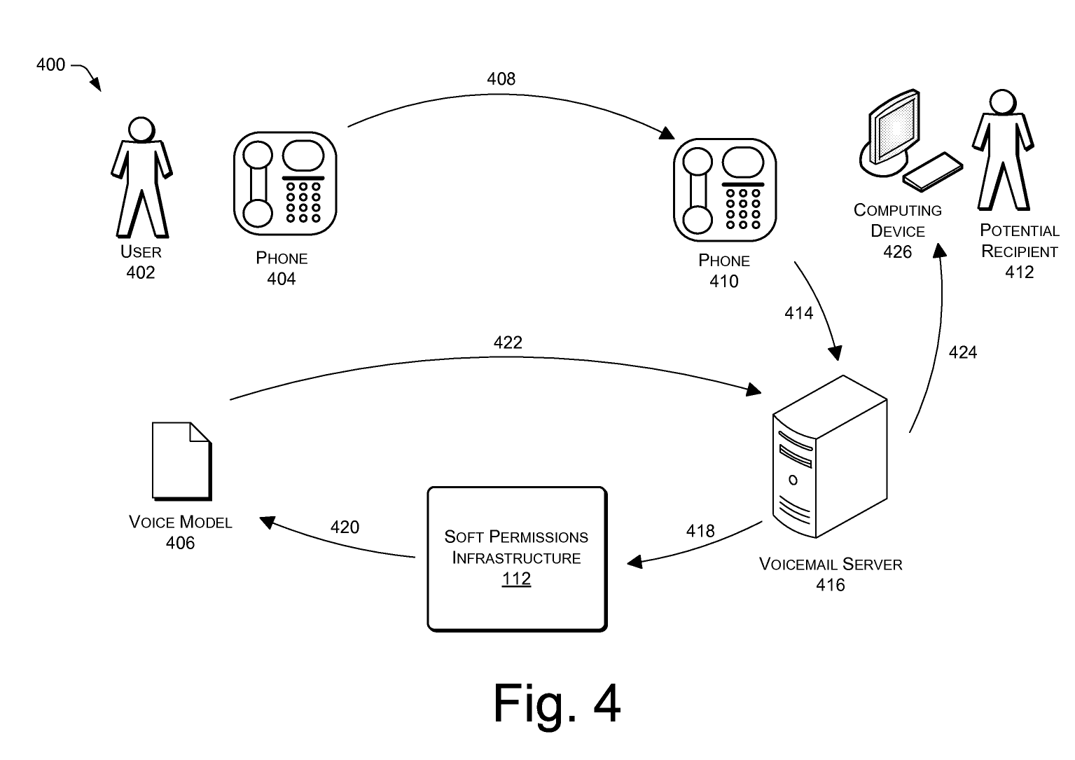

FIG. 4 shows an illustrative usage scenario of soft permissions for sharing of a user's speech recognition model for voice-to-text conversion. In this example, a user 402 has a phone 404 and a voice model 406 that allows conversion of speech from the user 402 into text. The voice model 406 may be used by the user 402 when dictating commands or text to a computer program such as a word processing program. The voice model 406 may also be used by a voicemail service to convert voice messages of the user 402 into text messages, e-mail messages, and the like. The voice model 406 may be based upon accent and pronunciation, frequency of word usage, custom words specifically added to the voice model 406, and the like. Thus, the voice model 406 may contain information that the user 402 considers private. Accordingly, the user 402 may wish to limit sharing of his or her voice model 406.

In this example, the user 402 places a call 408 from his or her phone 404 to the phone 410 of another person referred to here as a potential recipient 412. Although the potential recipient 412 receives the call 408 at his or her phone 410, the potential recipient 412 may or may not receive the voice model 406. Thus, the other person is only a potential recipient 412 of a document (i.e., the voice model 406) although he or she does receive the call 408.

In this illustrative scenario, the phone 410 of the potential recipient 412 may record the call 408 as a voicemail message 414 that is sent to a voicemail server 416 or similar apparatus for managing voicemail. The voicemail server 416 may store a recording of the call 408 as an audio file. The voicemail server 416 may also be configured to convert the audio file into an e-mail or other text document for communication to the potential recipient 412. In the absence of a specific voice model for the sender of the voicemail (i.e., the user 402) the voicemail server 416 may use a generic voice model to convert the speech in the auto file into text. However, because this generic voice model is not customized or adapted to the speech of the user 402 it will be less accurate than a speech-to-text conversion performed using the voice model 406, of the user 402. Previous examples discussed documents that are primarily used or reviewed directly by a human user. However, as shown here in this example of a voice model 406 some documents may be used primarily by computer systems and not used or viewed directly by a human user.

The voicemail server 416 may generate a request 418 for the voice model 406 of the user 402. This request 418 may be analyzed by the soft permissions infrastructure 112 as shown in FIGS. 1 and 2. The soft permissions infrastructure 112 may generate a soft permission 420 regarding sharing of the voice model 406 with the potential recipient 412. In one implementation, the previous phone call 408 from the user 402 to the potential recipient 412 may be interpreted by the soft permissions infrastructure 112 to infer that the user 402 would likely choose to grant the potential recipient 412 permission to receive his or her voice model 406. The soft permissions infrastructure 112 may make this inference by applying an algorithm representing the concept that if the user 402 chose to call the potential recipient 412 and leave a voicemail message 414 then the user 402 would allow the potential recipient 412 access to his or her voice model 406 in order to convert the voicemail message 414 to text.

Applying the soft permission 420 that gives the potential recipient 412 permission to receive the voice model 406 may result in the voice model 406 being transferred 422 to the voicemail server 416. The voicemail server 416 may use the voice model 406 to convert the voicemail message 414 to a textual representation such as an e-mail message and transfer the e-mail message 424 to a computing device 426 accessed by the potential recipient 412.

In this illustrative scenario the basis for deriving the soft permission 420 is simplified to include only the act of a phone call 408 from the user 402 to the potential recipient 412. However, the soft permissions infrastructure 112 may consider a larger number of factors when determining whether or not to allow that the recipient 412 access to the voice model 406. For example, if the call 408 was the first call between these two users then the soft permissions infrastructure 112 may infer that sharing permission should not be granted. Similarly, the nature of the phone number of the phone 410 may affect the inference made by the soft permissions infrastructure 112. For example, if the phone number is a 1-800 or other toll-free number the soft permissions infrastructure 112 may determine that the potential recipient 412 associated with that phone number should not be able to receive the voice model 406. Many additional factors and combinations of factors may also be utilized by the soft permissions infrastructure 112 to develop the illustrative soft permission 420 discussed above.

### Illustrative Processes

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

The processes are illustrated as a collection of blocks in logical flowcharts, which represent a sequence of operations that can be implemented in hardware, software, or a combination of hardware and software. For discussion purposes, the processes are described with reference to the system shown in FIGS. 1-4. However, the processes may be performed using different architectures and devices.

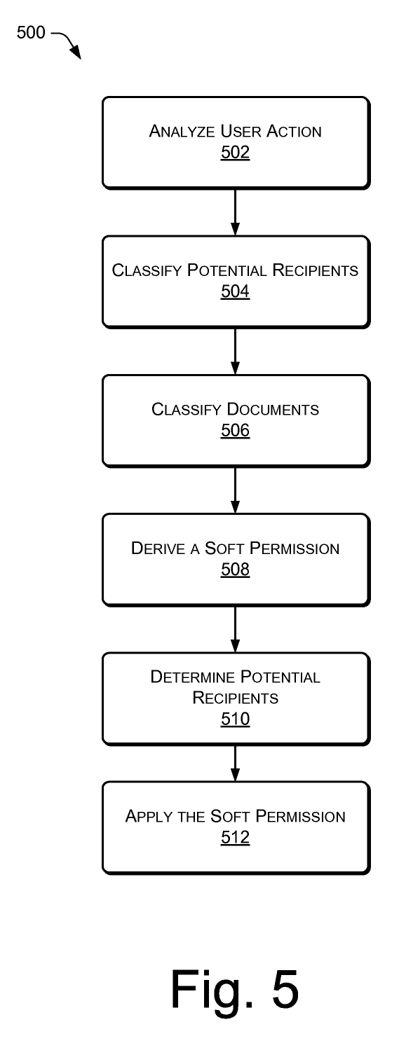

FIG. 5 illustrates a flowchart of a process 500 of determining potential recipients for a document. At 502, action of a user is analyzed. The action may be related to sharing of a first document with a recipient. For example, the user may have shared pictures with Joe, Susan, and David. The action may also include the user providing an explicit rule for sharing the first document with the recipient. For example, the user may provide a rule that pictures are to be shared with friends and Joe, Susan, and David are all friends of the user. The action may also include behavior that indicates a strength and type of relationship with a potential recipient. For example, the user may exchange e-mails with Joe almost every day. This action may indicate a strong connection between the user and Joe. Joe may also be included in a section of the user's address book as designated as “friends.” The action of including Joe in the friends section of the address book may indicate that the type of relationship with Joe is that of a friend.

The analysis performed at 502 may be performed in whole or in part by the soft permissions infrastructure 112 discussed above. In some implementations, analysis may include an inference based at least in part upon a mathematical model of past actions of the user. The past actions of the user may include, but are not limited to, indications that it is acceptable to share a document with a given potential recipient, affirmatively sharing a document such as by attaching it to an e-mail, designating a hard permission about what to share or not share and with whom, and the like. For example, the user may indicate that video files are acceptable to share with Joe and Susan.

At 504, potential recipients are classified. The potential recipients may be classified by the potential recipient analysis module 202 shown in FIG. 2. Classification of the potential recipients may be implemented by techniques similar to those discussed above with respect to FIG. 3. For example, each of Joe, Susan, and David may be classified as friends. A soft permission may be derived at least in part based upon the classification of the potential recipients.

At 506, documents are classified. The documents may be classified by the document analysis module 204 shown in FIG. 2. Classification of the documents may be implemented by techniques similar to those discussed above with respect to FIG. 3. The soft permission may be derived at least in part based upon the classification of the documents. A second document that may be shared with one or more of the potential recipients may be classified at 506. For example, the second document may be a video and the video may be placed in the same document class as the pictures shared with Joe, Susan, and David. The soft permission for sharing the second document may be derived at least in part based upon the document classification.

At 508, the soft permission for sharing documents is derived based at least in part on the analysis performed at 502, the classification of this recipients performed at 504, and/or the classification of documents performed at 506. The soft permission may be derived in whole or in part by the soft permissions infrastructure 112. The soft permission may be implemented as a binary condition such as share or do not share. The soft permission may alternatively be implemented as a probabilistic analysis indicating a degree of likelihood that the user, if explicitly queried, would choose to share or not share a particular document with a given potential recipient. In some implementations, the soft permission may only be acted upon if the probability or confidence level exceeds a threshold (e.g., implement only those soft permissions that are more than 80% likely to be accurate). In the same or a different implementation, the user may be queried about his or her desired sharing behavior for marginal cases (e.g., between 65% and 80% likely). For cases in which the confidence level is lower (e.g., less that 65% likely to be accurate) the soft permissions infrastructure 112 may take no action or the soft permissions infrastructure 112 may seek more information either from the user or from another source.

At 510, potential recipients of the second document are determined. The determination may be based at least in part on the soft permissions derived at 508. For example, it may be determined that David should also be included as a potential recipient for the video because the video is classified with the pictures that are shared with David and because David is classified as a friend like Joe and Susan who are permitted to receive the video. The soft permissions may be stored in the permissions database 110 shown in FIGS. 1 and 2.

At 512, the soft permission derived at 508 is applied to the second document. Application of the soft permissions may allow the second document to be shared with the potential recipients determined at 510. Alternatively, application of the soft permission may restrict sharing so that a document which was available to a particular recipient before application of the soft permission becomes unavailable after the soft permission is applied at 512.

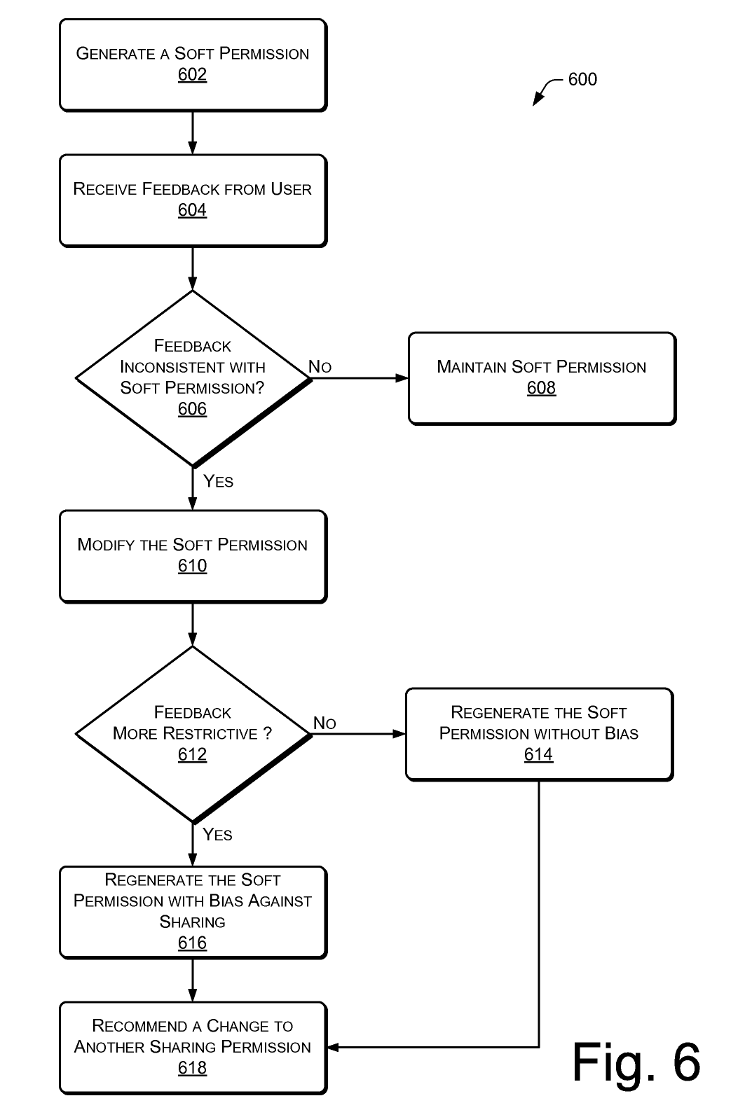

FIG. 6 illustrates a flowchart of a process 600 of generating and possibly modifying soft permissions. At 602 a soft permission for sharing documents is generated. The soft permission may be generated based in part on inferences derived from past document sharing behavior of a user. The soft permission may be generated by the soft permissions infrastructure 112 as discussed earlier. The soft permission may additionally or alternatively generated by acts similar to those discussed with respect to FIG. 5 above.

At 604, feedback regarding the soft permission is received from the user. Generally, the feedback may indicate that the soft permission is or is not in accord with a permission setting that the user would have set manually. The feedback may include the user explicitly indicating a hard permission that is at least partially inconsistent with the soft permission. For example, the soft permission may indicate that it is acceptable to share videos with David, but the user may create a hard permission that restricts video sharing to only those users that are members of a video club website of which David is not a member.

The feedback may also include the user sharing a document in a manner that is at least partially inconsistent with the soft permission. For example, the soft permission may indicate that financial documents are highly private and should not be shared with any other users. However, the user may include a link to a bank statement in an instant message to his or her spouse and this action may serve as feedback that is inconsistent with the no-sharing effect of the soft permission.

At 606, it is determined if the feedback is inconsistent with the soft permission. If the feedback is consistent with the soft permission then that may validate the accuracy of the soft permission and indicate to the system that there is no need to change the soft permission. Accordingly, process 600 may proceed along the “no” path to 608. At 608, the soft permission is maintained. If the feedback from the user is inconsistent in whole or part with the soft permission then process 600 proceeds along the “yes” path to 610.

At 610, the soft permission is modified based at least in part on the feedback received at 604. The soft permission may be modified based on inferences derived from past sharing behavior of the user and from the feedback received from the user at 604. In some implementations, the modification of the soft permission may use the same algorithms, computer learning models, artificial intelligence, etc. that was used to originally generate the soft permission, but take into account the inconsistent feedback received from the user. Depending on the specific data and computational techniques used to generate and then to modify the soft permission, it is possible that the soft permission may remain the same even after the inconsistent feedback. However, in order to account for the inconsistent feedback received from the user, it is also possible that the regenerated soft permission will be different from the original soft permission.

At 612, it is determined if the feedback received from the user at 604 indicates more restrictive sharing than the soft permission. In other words, the feedback from the user may be more restrictive if the soft permission was allowing the system to share documents to a greater extent than the user desired. However, the soft permission may also be overly restrictive and in that case the user feedback would imply that less restrictive sharing permissions accurately represent the user's intent.

If the feedback was not more restrictive (i.e., the user would prefer the same or greater sharing), process 600 may proceed along the “no” path to 614. At 614, the soft permission may be regenerated without changing the bias for or against privacy that was used to initially generate the soft permission.

However, if the feedback from the user indicates that more restrictive sharing permissions are desired, process 600 may proceed along the “yes” path to 616. At 616, the soft permission is regenerated using additional inferences biased against sharing documents. This bias towards privacy helps keep the system from allowing sharing in situations where the user would choose to limit sharing. The inference module 206 of FIG. 2 may use a different and more restrictive or more conservative algorithm to derive a soft permission in response to user feedback that suggests sharing of documents should be decreased. The decrease in sharing could be implemented as a decrease in the number of potential recipients for a given document and/or as a decrease in number of documents that a given potential recipient is permitted to receive.

At 618, a change to another sharing permission may be recommended to the user based on the modification of the soft permission. For example, if the user feedback indicates that more restrictive sharing of videos is desired then the system may recommend that the user also apply more restrictive sharing permissions to pictures. The recommendation may suggest that the user modify a soft permission or a hard permission. For example, the system may ask the user if he or she would like the soft permission for sharing pictures regenerated in light of the feedback received regarding the sharing of videos. Also, the system may suggest that a hard permission previously provided by the user is potentially inconsistent with the most recent feedback from the user and then ask the user if he or she wishes to manually change the hard permission or have the system generate a new soft permission in place of the hard permission.

### Illustrative Computing Device

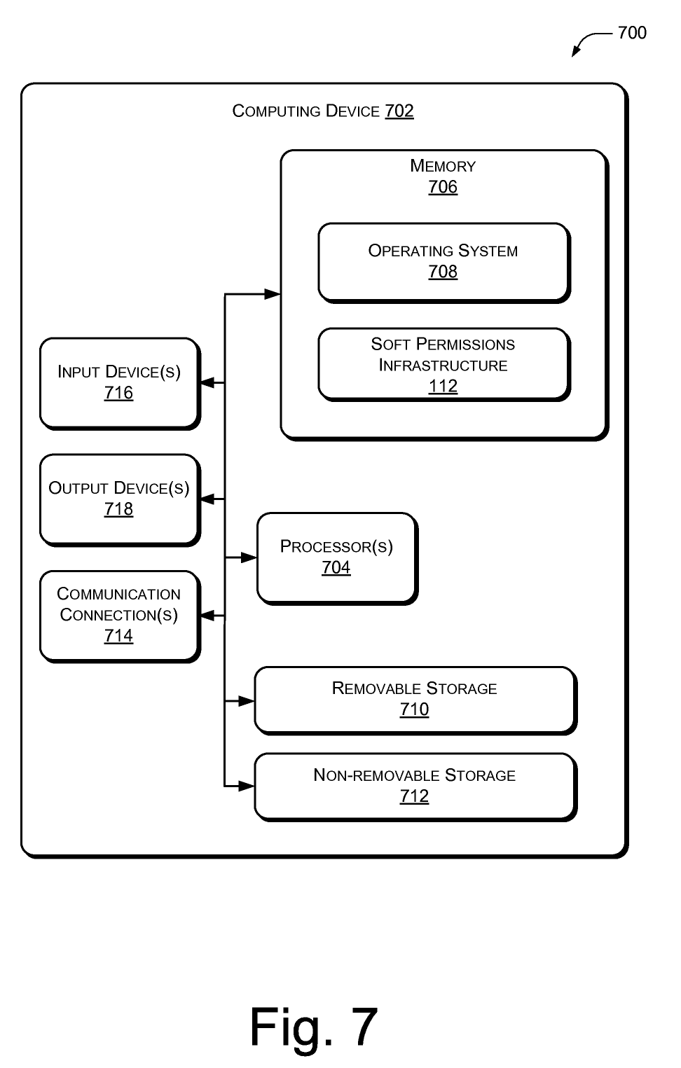

FIG. 7 is a block diagram 700 showing an illustrative computing device 702. The computing device 702 may be configured as any suitable system capable of running, in whole or part, the soft permissions infrastructure 112. For example, the computing device 702 may be implemented as the computing device 104 shown in FIG. 1, one or more of the computing devices used by the potential recipients 114 of FIG. 1, a server computer connected to the network 106 of FIG. 1, a distributed system of multiple hardware devices such as a peer-to-peer or other distributed system.

The computing device 702 comprises one or more processor(s) 704 and a memory 706. The processor(s) 704 may be implemented as appropriate in hardware, software, firmware, or combinations thereof. Software or firmware implementations of the processor(s) 704 may include computer- or machine-executable instructions written in any suitable programming language to perform the various functions described.

The memory 706 may store programs of instructions that are loadable and executable on the processor(s) 704, as well as data generated during the execution of these programs. Examples of programs and data stored on the memory 706 include an operating system 708 for controlling operations of hardware and software resources available to the computing device 702 as well as the soft permissions infrastructure 112 with the features described above. Depending on the configuration and type of computing device 702, the memory 706 may be volatile (such as RAM) and/or non-volatile (such as ROM, flash memory, etc.).

The computing device 702 may also include additional computer-readable media such as removable storage 710 and/or non-removable storage 712. The storage devices and any associated computer-readable media may provide storage of computer readable instructions, data structures, program modules, and other data. Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The computing device 702 may also contain communication connection(s) 714 that allows the computing device 702 to communicate with other devices such as the computing device 104 shown in FIG. 1 and/or computing devices operated by the potential recipients 114 of FIG. 1. Communication connection(s) 714 is an example of a mechanism for receiving and sending communication media. By way of example, and not limitation, communication media includes wired media such as a wired network or direct-wired connection, and wireless media such as acoustic, RF, infrared, and other wireless media.

The computing device 702 may also include input device(s) 716 such as a keyboard, mouse, pen, voice input device, touch input device, stylus, and the like, and output device(s) 718 such as a display, monitor, speakers, printer, etc. All these devices are well known in the art and need not be discussed at length.

The computing device 702 presents one illustrative architecture of these components residing on a single system. However, these components may reside in multiple other locations, servers, or systems. Furthermore, two or more of the illustrated components may combine to form a single component at a single location.

### CONCLUSION

The subject matter described above can be implemented in hardware, software, or in both hardware and software. Although implementations have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations of setting permission for sharing documents. For example, the methodological acts need not be performed in the order or combinations described herein, and may be performed in any combination of one or more acts.

1. A system comprising:
a processor;
a memory communicatively coupled to the processor;
a potential recipient analysis module stored in the memory and executable at the processor to analyze data derived at least in part from interactions between a user and potential recipients of documents to determine a level of trust for individual ones of the potential recipients;
a document analysis module stored in the memory and executable at the processor to perform an analysis of the documents to determine a level of document privacy;
an inference module stored in the memory and executable at the processor to derive soft permissions for sharing the documents based at least in part on the level of trust and the level of document privacy; and
an implementation module stored in the memory and executable at the processor to implement soft permissions derived by the inference module.

2. The system of claim 1, wherein the interactions between the user and the potential recipients comprise one or more of an e-mail exchange, a sharing of documents, or a categorization of one or more of the potential recipients by the user.

3. The system of claim 1, wherein the interactions between the user and the potential recipients comprise one or more of both the user and the potential recipients receiving an invitation to a same location at a same time or both the user and the potential recipients being present at the same location at the same time.

4. The system of claim 1, wherein the analysis comprises one or more of an analysis of text within the documents, analysis of metadata associated with the documents, or analysis of a type of document.

5. The system of claim 1, wherein the inference module is further configured to derive the soft permissions using one or more of a support vector machine, a neural network, an expert system, a Bayesian belief network, a decision tree, fuzzy logic, or a probabilistic classification model.

6. The system of claim 1, wherein the implementation module implements the soft permissions by one or more of:
automatically applying the soft permissions to share a one of the documents; or
querying the user regarding sharing the one of the documents according to the soft permissions.

7. The system of claim 1, further comprising a permissions database comprising one or more hard permissions explicitly provided by the user, wherein inference module is further configured to derive the soft permissions based at least in part on the hard permissions.

8. The system of claim 1, further comprising a recommendation generator configured to identify one or more documents or one or more potential recipients for which a currently applied sharing permission results in a different sharing decision than one of the soft permissions and generating a recommendation to change the currently applied sharing permission.

9. A computer-implemented method comprising:
under control of one or more processors configured with executable instructions,
analyzing an action of a user related to sharing a first document with a recipient;
deriving, based at least in part on the analyzing, a soft permission for sharing documents;
determining potential recipients of a second document, the determining based at least in part on the soft permission; and
applying the soft permission to the second document.

10. The computer-implemented method of claim 9, wherein the action of the user comprises the user providing an explicit rule for sharing the first document with the recipient.

11. The computer-implemented method of claim 9, wherein the action of the user comprises the user sharing the first document with the recipient.

12. The computer-implemented method of claim 9, wherein the action of the user comprises behavior that indicates a strength and type of relationship with a potential recipient.

13. The computer-implemented method of claim 12, wherein the strength and type of relationship with the potential recipient is based at least in part on a relationship between the user and a third person and a relationship between the potential recipient and the third person.

14. The computer-implemented method of claim 9, wherein the analysis comprises an inference based at least in part upon a mathematical model of past actions of the user.

15. The computer-implemented method of claim 9, wherein the deriving the soft permission is based in part on a classification of one or more of the potential recipients.

16. The computer-implemented method of claim 9, wherein the deriving the soft permission is based in further part on a classification of the second document.

17. One or more computer-readable media storing computer-executable instructions that, when executed by a processor, configure the processor to perform acts comprising:
generating a soft permission for sharing documents based at least in part on inferences derived from past document sharing behavior of a user;
receiving feedback from the user regarding the soft permission; and
modifying the soft permission based at least in part on the feedback from the user.

18. The one or more computer storage media of claim 17, wherein the feedback comprises the user explicitly indicating a hard permission that is at least partially inconsistent with the soft permission.

19. The one or more computer storage media of claim 17, wherein the feedback comprises the user sharing a document in a manner that is at least partially inconsistent with the soft permission.

20. The one or more computer storage media of claim 17, wherein the modifying comprises regenerating the soft permission based at least in part on inferences derived from the past document sharing behavior of the user and from the feedback from the user.

21. The one or more computer storage media of claim 20, further comprising determining that the user feedback indicates more restrictive sharing than the soft permission, the regenerating the soft permission utilizes inferences biased against sharing documents.

22. The one or more computer storage media of claim 17, further comprising recommending a change to an other sharing permission based at least in part on the modifying the soft permission.

23. A system comprising:
a processor;
a memory communicatively coupled to the processor;
a potential recipient analysis module stored in the memory and executable at the processor to generate a social graph based at least in part on analysis of relationships between the user and a plurality of potential recipients;
a document analysis module stored in the memory and executable at the processor to perform an analysis of the documents to determine a level of document privacy;
an inference module stored in the memory and executable at the processor to derive soft permissions for sharing the documents based at least in part on the social graph and the level of document privacy; and
an implementation module stored in the memory and executable at the processor to implement a sharing action.

24. The system of claim 23, wherein the relationships between the user and the potential recipients are received from an external system maintaining, at least in part, a social network that includes the user and one or more of the plurality of potential recipients.

25. The system of claim 23, wherein the inference module derives the soft permissions based at least in part on a number of degrees of separation in the social graph between the user and one of the plurality of potential recipients.

26. The system of claim 23, wherein the sharing action is selected from one of: sharing one or more of the documents with one or more of the potential recipients, preventing sharing of one or more of the documents with one or more of the potential recipients, querying the user, or seeking additional information from a source other than the user.

27. The system of claim 26, wherein the sharing action is selected based at least in part on a confidence level assigned to each of multiple sharing actions, the confidence level determined at least in part by machine learning.
